(19) United States
(12) Patent Application Publication
(10) Pub. No.: US 2024/0322575 A1
(43) Pub. Date: Sep. 26, 2024

(54) SMART GLASSES

(71) Applicant: SHENZHEN SHOKZ CO., LTD., Shenzhen (CN)

(72) Inventors: Gong YUE, Shenzhen (CN); Jingbo QIU, Shenzhen (CN)

(73) Assignee: SHENZHEN SHOKZ CO., LTD., Shenzhen (CN)

(21) Appl. No.: 18/736,481

(22) Filed: Jun. 6, 2024

Related U.S. Application Data
(63) Continuation of application No. PCT/CN2022/096854, filed on Jun. 2, 2022.

(51) Int. Cl. H02J 7/00; G02C 11/00

(52) U.S. Cl. CPC H02J 7/0018; G02C 11/10; H02J 7/00032; H02J 7/0049; H02J 7/00712

(57) ABSTRACT

The present disclosure provides smart glasses, including a first glasses temple assembly and a second glasses temple assembly. The first glasses temple assembly includes a first charging module, a first battery, and a first control module, the second glasses temple assembly includes a second charging module, a second battery, and a second control module, and the first control module and the second control module are communicatively connected to each other to perform charging information interactions, so as to control the first charging module and the second charging module to cooperatively charge the first battery and the second battery, respectively. Technical problems, such as only one of the first battery and the second battery is charged and the other is not charged, the difference between the current battery level of the first battery and the current battery level of the second battery are relatively large, etc., are avoided.

### CROSS REFERENCE TO RELATED APPLICATIONS

This application is a Continuation of International Application No. PCT/CN2022/096854 filed on Jun. 2, 2022, the entire contents of which are incorporated herein by reference.

### TECHNICAL FIELD

The present disclosure relates to the technical field of electronic devices, and in particular, to smart glasses.

### BACKGROUND

With the increasing popularity of electronic devices, the electronic devices have become indispensable social and entertainment tools in people's daily life, and people's requirements for the electronic devices are also increasing. Taking smart glasses as an example, a speaker can be disposed in each of two glasses temples of the smart glasses, so as to realize acoustic functions (e.g., true wireless stereo (TWS) audio playback, phone call, etc.) when the smart glasses establish a communication connection with terminal devices (e.g., mobile phones, tablet computers, etc.) via wireless communication techniques (e.g., Bluetooth, etc.).

### SUMMARY

Some embodiments of the present disclosure provide smart glasses. The smart glasses may include a first glasses temple assembly and a second glasses temple assembly. The first glasses temple assembly may include a first charging module, a first battery, and a first control module, the second glasses temple assembly may include a second charging module, a second battery, and a second control module, and the first control module and the second control module may be communicatively connected to each other to perform charging information interactions, so as to control the first charging module and the second charging module to cooperatively charge the first battery and the second battery, respectively.

In some embodiments, the first control module and the second control module may be configured to perform an interaction on a connection state between a charger and at least one of the first charging module and the second charging module, when the first charging module and the second charging module are connected to the charger, control the first charging module and the second charging module to cooperatively charge the first battery and the second battery, respectively, and when either the first charging module or the second charging module is not connected to the charger, prohibit the first charging module and the second charging module from charging the first battery and the second battery, respectively.

In some embodiments, the first control module may be configured to send first indication information to the second control module when the first charging module is connected to the charger, the second control module may be configured to control the second charging module to charge the second battery and send second indication information to the first control module when the second charging module is connected to the charger and the second control module receives the first indication information, and the first control module may be further configured to control the first charging module to charge the first battery in response to the second indication information.

In some embodiments, the second control module may be configured to prohibit the second charging module from charging the second battery when the second charging module is not connected to the charger or does not receive the first indication information, and the first control module may be configured to prohibit the first charging module from charging the first battery when the first charging module is not connected to the charger or does not receive the second indication information.

In some embodiments, when the first control module sends the first indication information and does not receive the second indication information within a predetermined time, the first control module may be configured to send an alarm signal.

In some embodiments, the first glasses temple assembly may further include a first charging indicator, the second glasses temple assembly may further include a second charging indicator. When the first charging module and the second charging module are connected to the charger, the first control module and the second control module may be configured to control the first charging indicator and the second charging indicator to issue charging indications, respectively, and when either the first charging module or the second charging module is not connected to the charger, the first control module and the second control module may be configured to prohibit the first charging module and the second charging module from issuing the charging indications, respectively.

In some embodiments, the first control module and the second control module may be configured to perform an interaction on a current battery level of the first battery and a current battery level of the second battery, and control the first charging indicator and the second charging indicator to issue the charging indications based on a lower one of the current battery level of the first battery and the current battery level of the second battery.

In some embodiments, the first control module and the second control module may be further configured to adjust charging powers of the first charging module and the second charging module based on a difference between the current battery level of the first battery and the current battery level of the second battery.

In some embodiments, the first glasses temple assembly may further include a first fully-charged indicator, the second glasses temple assembly may further include a second fully-charged indicator. The first control module and the second control module may be configured to perform an interaction on at least one of a fully-charged state of the first battery and a fully-charged state of the second battery; control the first fully-charged indicator and the second fully-charged indicator to issue fully-charged indications when each of the first battery and the second battery is in the fully-charged state; and prohibit the first fully-charged indicator and the second fully-charged indicator from issuing the fully-charged indications when either the first battery or the second battery is not in the fully-charged state.

In some embodiments, the first control module may be configured to send third indication information to the second control module when the first battery is in the fully-charged state, the second control module may be configured to control the second fully-charged indicator to issue the fully-charged indication and send fourth indication information to the first control module when the second battery is in the fully-charged state and receives the third indication information from the first control module, and the first control module may be further configured to control the first fully-charged indicator to issue the fully-charged indication in response to the fourth indication information from the second control module.

In some embodiments, the second control module may be configured to send third indication information to the first control module when the second battery is in the fully-charged state, the first control module may be configured to control the first fully-charged indicator to issue the fully-charged indication and send fourth indication information to the second control module when the first battery is in the fully-charged state and receives the third indication information from the second control module, and the second control module may be further configured to control the second fully-charged indicator to issue the fully-charged indication in response to the fourth indication information from the first control module.

The beneficial effects of the present disclosure may include that the smart glasses of the present disclosure can not only improve an endurance capacity of the smart glasses when the smart glasses realize stereo by supplying power to a first speaker and a second speaker through the first battery and the second battery, respectively, but also control the first charging module and the second charging module to cooperatively charge the first battery and the second battery by exchanging charging information of left and right glasses temples (i.e., the first glasses temple assembly and the second glasses temple assembly) through a communication connection between the first control module and the second control module. Technical problems, such as only one of the first battery and the second battery is charged and the other is not charged, the difference between the current battery level of the first battery and the current battery level of the second battery are relatively large, etc., are solved, thereby ensuring the normal use of the smart glasses.

### BRIEF DESCRIPTION OF THE DRAWINGS

To more clearly illustrate the technical solutions in the embodiments of the present disclosure, the following descriptions will briefly introduce the drawings that need to be used in the description of the embodiments. Obviously, the accompanying drawing in the following descriptions are merely some embodiments of the present disclosure. For those skilled in the art, other drawings may also be obtained according to these drawings without creative work, wherein:

FIG. 1 is a schematic diagram illustrating a structure of smart glasses according to some embodiments of the present disclosure;

FIG. 2 is a schematic diagram illustrating a circuit structure of smart glasses according to some embodiments of the present disclosure;

FIG. 3 is a schematic diagram illustrating a charging sequence of smart glasses according to some embodiments of the present disclosure.

### DETAILED DESCRIPTION

The present disclosure is described in further detail for the following with reference to the accompanying drawings and embodiments. In particular, it is noted that the following embodiments are only configured to illustrate the present disclosure, but do not limit the scope of the present disclosure. Similarly, the following embodiments are only a part of the embodiments of the present disclosure, but not all of them. All other embodiments obtained by those skilled in the art without making creative efforts belong to the scope of protection of the present disclosure.

Reference to “embodiments” in the present disclosure means that particular features, structures, or characteristics described in connection with embodiments may be included in at least one embodiment of the present disclosure. It is understood explicitly and implicitly by those skilled in the art that the embodiments described herein can be combined with other embodiments.

During the long-term research and development work, the inventor of the present disclosure found that TWS Bluetooth earphones not only allow single use, but also have a charging case for battery level management when charging. Different from the TWS Bluetooth earphones, smart glasses described in the present disclosure are used as a whole, and two glasses temples of the smart glasses must be used at the same time. Speakers in the two glasses temples require batteries for power supply and a main board for control when the speakers work. At this time, in a technical solution that one of the two glasses temples is disposed with a battery and the other is disposed with a main board to drive the two speakers, the smart glasses are prone to technical problems, such as a relatively short endurance capacity due to an insufficient battery capacity. In a technical solution that each glasses temple is disposed with a battery and a main board to drive one corresponding speaker, although it is conducive to solving the above technical problem of the relatively short endurance capacity, when the batteries in the two glasses temples are charged respectively and independently, it is prone to lead to other technical problems, such as that only one of the two batteries is charged and the other is not charged, a relatively large difference exists between battery levels of the two batteries, etc. Therefore, the present disclosure provides the following embodiments to solve the corresponding technical problems.

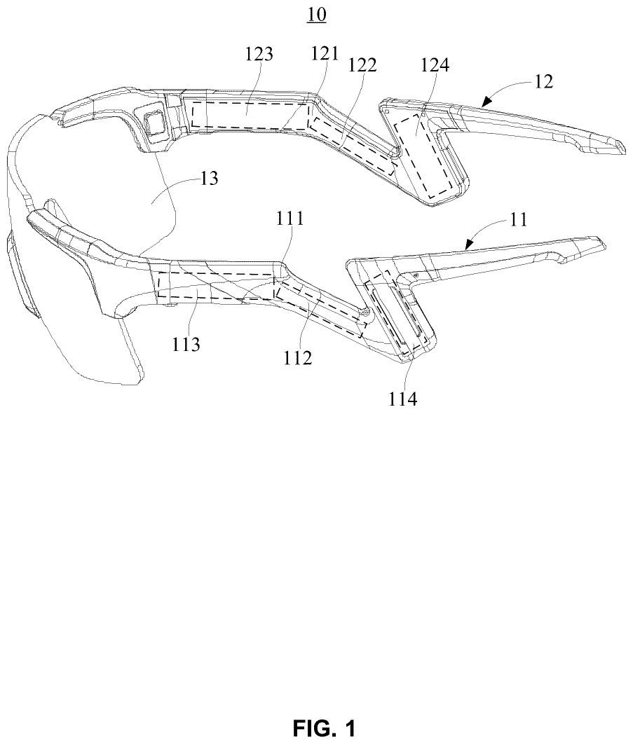

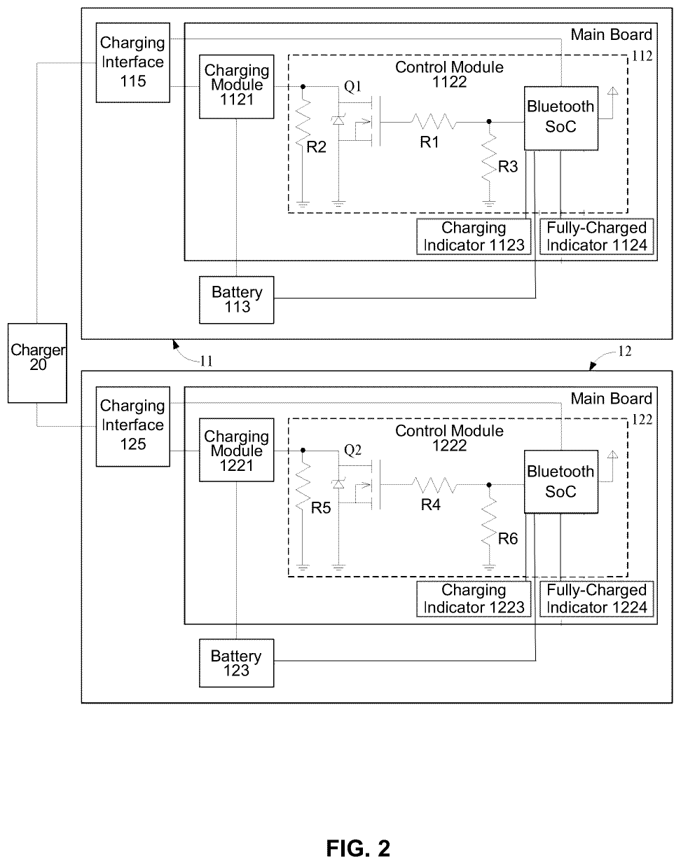

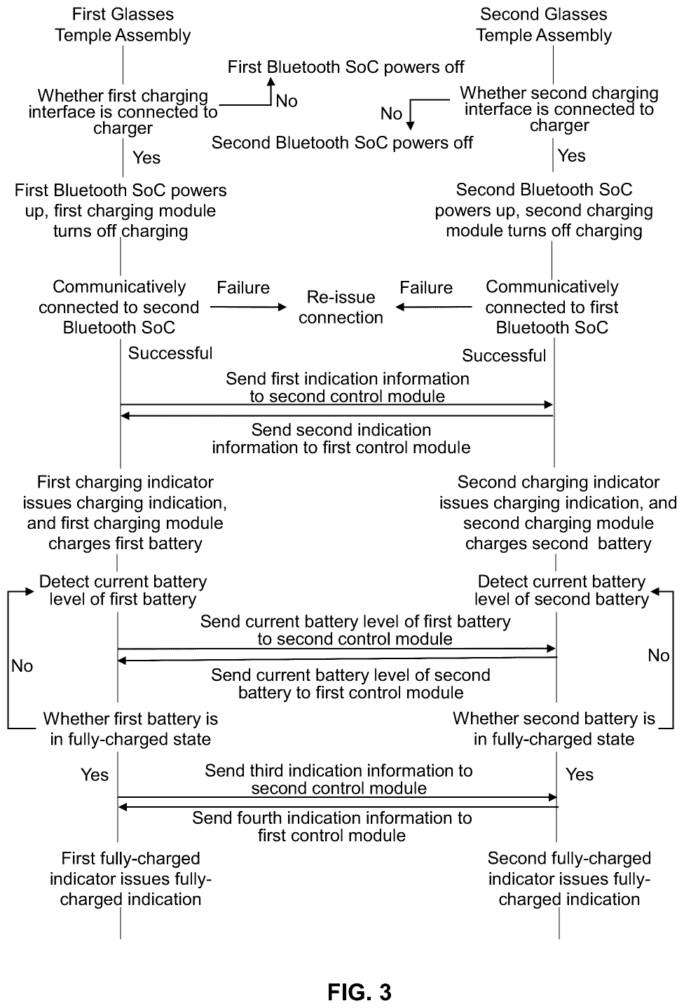

Referring to FIG. 1 to FIG. 3, FIG. 1 is a schematic diagram illustrating a structure of smart glasses according to some embodiments of the present disclosure. FIG. 2 is a schematic diagram illustrating a circuit structure of smart glasses according to some embodiments of the present disclosure. FIG. 3 is a schematic diagram illustrating a charging sequence of smart glasses according to some embodiments of the present disclosure.

In the present disclosure, smart glasses 10 may be a wearable device that are worn on the head of a user and have a sound playback function. The smart glasses 10 may be audio glasses with a single function, or multi-functional glasses combining the audio glasses with virtual reality (VR) glasses, augmented reality (AR) glasses, mixed reality (MR) glasses, mediated reality (MR) glasses, etc. Audio glasses is described in the present disclosure as exemplary smart glasses for the purposes of illustration.

Merely by way of example, in combination with FIG. 1, the smart glasses 10 may include a first glasses temple assembly 11, a second glasses temple assembly 12, and a visual structure 13. The first glasses temple assembly 11 and the second glasses temple assembly 12 may be respectively connected (e.g., detachably connected) to both ends of the visual structure 13 and extend in a same direction. In a wearing state, one of the first glasses temple assembly 11 and the second glasses temple assembly 12 may be supported on a left ear of the user, and the other may be supported on a right ear of the user. The visual structure 13 may satisfy visual requirements of the user.

Further, the first glasses temple assembly 11 may include a first housing 111 connected to an end of the visual structure 13 and a first main board 112, a first battery 113, and a first speaker 114 disposed within the first housing 111. The first battery 113 and the first speaker 114 may be electrically connected to the first main board 112, so as to allow the first battery 113 to provide power to the first speaker 114 under a control of the first main board 112. Similarly, the second temple assembly 12 may include a second housing 121 connected to the other end of the visual structure 13 and a second main board 122, a second battery 123, and a second speaker 124 disposed within the second housing 121. The second battery 123 and the second speaker 124 may be electrically connected to the second main board 122, so as to allow the second battery 123 to provide power to the second speaker 124 under a control of the second main board 122. The first speaker 114 and the second speaker 124 may include a bone conduction speaker (i.e., mechanical vibrations generated by the speaker are mainly propagated through a medium such as a skull of the user), an air conduction speaker (i.e., mechanical vibrations generated by the speaker are mainly propagated through a medium such as air), and/or a speaker combining the bone conduction and the air conduction. Relevant structures of the speakers are well known to those skilled in the field, which are not repeated herein.

Further, the visual structure 13 may include a frame and two lenses embedded in the frame. Alternatively, the visual structure 13 may include one lens (e.g., the two lenses are combined into the one lens). The lens may include an optical plastic component.

Merely by way of example, in combination with FIG. 2, the first glasses temple assembly 11 may further include a first charging module 1121 and a first control module 1122. For example, the first charging module 1121 and the first control module 1122 may be integrated on the first main board 112. The first glasses temple assembly 11 may further include a first charging interface 115 electrically connected to the first main board 112. For example, the first charging interface 115 may be disposed within the first housing 111 and a portion of the first charging interface 115 may be exposed. The first control module 1122 may be configured to control the first charging module 1121 to charge the first battery 113, and the first charging interface 115 may be configured to connect to a first output plug of a charger 20. For example, the first charging interface 115, the first battery 113, and the first control module 1122 may be connected to corresponding pins on the first charging module 1121. Similarly, the second temple assembly 12 may also include a second charging module 1221 and a second control module 1222. For example, the second charging module 1221 and the second control module 1222 may be integrated on the second main board 122. The second temple assembly 12 may further include a second charging interface 125 electrically connected to the second main board 122. For example, the second charging interface 125 may be disposed within the second housing 121 and a portion of the second charging interface 125 may be exposed. The second control module 1222 may be configured to control the second charging module 1221 to charge the second battery 123, and the second charging interface 125 may be configured to connect to a second output plug of the charger 20. For example, the second charging interface 125, the second battery 123, and the second control module 1222 may be connected to corresponding pins on the second charging module 1221. Further, the first charging interface 115 and the second charging interface 125 may include metal pieces fixed relative to the corresponding housings, pogo-PINs capable of moving relative to the corresponding housings, or the like. The first output plug of the charger 20 and the second output plug of the charger 20 may be magnetically attracted to the first housing 111 and the second housing 121, respectively, so as to ensure that the first output plug of the charger 20 and the second output plug of the charger 20 are electrically connected to the first charging interface 115 and second charging interface 125, respectively.

Further, the first glasses temple assembly 11 may also include a first charging indicator 1123 and a first fully-charged indicator 1124 that are electrically connected to the first main board 112. For example, the first charging indicator 1123 and the first fully-charged indicator 1124 may be affixed to the first main board 112 through surface mount technology (SMT), and connected to corresponding pins on the first control module 1122, respectively. When the first output plug of the charger 20 is not connected to the first charging interface 115, the first control module 1122 may control the first charging indicator 1123 and the first fully-charged indicator 1124 not to issue corresponding indications. When the first output plug of the charger 20 is connected to the first charging interface 115, the first control module 1122 may control the first fully-charged indicator 1124 not to issue the corresponding indication, but control the first charging indicator 1123 to issue a charging indication. When the first battery 113 is fully charged, the first control module 1122 may control the first charging indicator 1123 not to issue the corresponding indication, but control the first fully-charged indicator 1124 to issue a fully-charged indication. The first charging indicator 1123 and the first fully-charged indicator 1124 may include an optical-type indicator (e.g., a light-emitting diode (LED)) that emits light visible to the human eyes, an acoustic-type indicator (e.g., a buzzer) that emits sound audible to the human ears, or the like.

Similarly, the second glasses temple assembly 12 may also include a second charging indicator 1223 and a second fully-charged indicator 1224 that are electrically connected to the second main board 122. For example, the second charging indicator 1223 and the second fully-charged indicator 1224 may be affixed to the second main board 122 through SMT, and connected to corresponding pins on the second control module 1222, respectively. When the second output plug of the charger 20 is not connected to the second charging interface 125, the second control module 1222 may control the second charging indicator 1223 and the second fully-charged indicator 1224 not to issue corresponding indications. When the second output plug of the charger 20 is connected to the second charging interface 125, the second control module 1222 may control the second fully-charged indicator 1224 not to issue the corresponding indication, but control the second charging indicator 1223 to issue a charging indication. When the second battery 123 is fully charged, the second control module 1222 may control the second charging indicator 1223 not to issue the corresponding indication, but control the second fully-charged indicator 1224 to issue a fully-charged indication. The second charging indicator 1223 and the second fully-charged indicator 1224 may include an optical-type indicator (e.g., the LED) that emits light visible to the human eyes, an acoustic-type indicator (e.g., the buzzer) that emits sound audible to the human ears, or the like.

It should be noted that: the connection in the present disclosure refers to that the first output plug and the second output plug of the charger 20 are electrically conductive to the first charging interface 115 and the second charging interface 125, respectively. That is, the connection is a prerequisite for the charger 20 to be able to charge the first battery 113 and the second battery 123, respectively.

Merely by way of example, the first charging module 1121 and the second charging module 1221 may include charging management integrated circuits (IC) integrated on the first main board 112 and the second main board 122, respectively. The charging management ICs may control and detect currents, voltages, and even temperatures during charging/discharging processes, so as to prevent the first battery 113 and the second battery 123 from experiencing unsafe risks (e.g., over-discharging, over-voltage, over-charging, over-temperature, etc.), thereby effectively protecting a life of the batteries and safety of the user. The charge management ICs are well known to those skilled in the art, which are not repeated herein. The first charging interface 115 and the first battery 113 may be connected to the first charging module 1121, respectively, and the second charging interface 125 and the second battery 123 may be connected to the second charging module 1221, respectively.

Further, the first control module 1122 may include a first Bluetooth system on chip (SoC), a resistor R1, a resistor R2, and a switching transistor Q1. A general-purpose input/output (GPIO) pin of the first Bluetooth SoC may be connected to a gate of the switching transistor Q1 via the resistor R1, a drain of the switching transistor Q1 may be connected to a pin on the first charging module 1121, and a source of the switching transistor Q1 may be grounded. An end of the resistor R2 and the drain of the switching transistor Q1 may be connected to the same pin on the first charging module 1121, and the other end of the resistor R2 may be grounded. The resistor R2 may be a negative temperature coefficient thermistor (also referred to as “NTC”), and the pin on the first charging module 1121 connected to the resistor R2 may be an NTC voltage detection pin. Further, the first charging interface 115 may be connected to the first Bluetooth SoC, so as to allow the first Bluetooth SoC to detect and determine whether the first output plug of the charger 20 is connected to the first charging interface 115. The first battery 113 may be connected to the first Bluetooth SoC, so as to allow the first Bluetooth SoC to detect a current battery level of the first battery 113. Based on this, when the first Bluetooth SoC detects that a charging input voltage from the charger 20 is greater than or equal to a preset threshold voltage, it may be determined that the first output plug of the charger 20 is connected to the first charging interface 115. At this time, the first Bluetooth SoC may reset and power on, and may output a charging control signal CHRG_EN# to the gate of the switching transistor Q1. When the charging control signal CHRG_EN# is a high level, the switching transistor Q1 may conduct, and then the first charging module 1121 may turn off charging. That is, the charger 20 may be prohibited from charging the first battery 113. When the charging control signal CHRG_EN# is a low level, the switching transistor Q1 may cut off, and the first charging module 1121 may operate normally. That is, the charger 20 may be allowed to charge the first battery 113. Further, the first control module 1122 may also include a resistor R3. An end of the resistor R3 may be connected between the GPIO pin of the first Bluetooth SoC and the resistor R1, and the other end of the resistor R3 may be grounded, so as to provide a default chargeable state for the first control module 1122. A value of the resistor R3 may be greater than a value of the resistor R1. Based on this, when the first Bluetooth SoC is unable to be powered up and switched on due to a loss of power of the first battery 113, the charger 20 may charge the first battery 113 until the first Bluetooth SoC is normally powered up, and then the first Bluetooth SoC may take over the control on the first charging module 1121.

Similarly, the second control module 1222 may include a second Bluetooth SoC, a resistor R4, a resistor R5, and a switching transistor Q2. A GPIO pin of the second Bluetooth SoC may be connected to a gate of the switching transistor Q2 via the resistor R4, a drain of the switching transistor Q2 may be connected to a pin on the second charging module 1221, and a source of the switching transistor Q2 may be grounded. An end of the resistor R5 and the drain of the switching transistor Q2 may be connected to the same pin on the second charging module 1221, and the other end of the resistor R5 may be grounded. The resistor R5 may be a negative temperature coefficient thermistor (also referred to as “NTC”), and the pin on the second charging module 1221 connected to the resistor R5 may be an NTC voltage detection pin. Further, the second charging interface 125 may be connected to the second Bluetooth SoC, so as to allow the second Bluetooth SoC to detect and determine whether the second output plug of the charger 20 is connected to the second charging interface 125. The second battery 123 may be connected to the second Bluetooth SoC, so as to allow the second Bluetooth SoC to detect a current battery level of the second battery 123. Based on this, when the second Bluetooth SoC detects that a charging input voltage from the charger 20 is greater than or equal to the preset threshold voltage, it may be determined that the second output plug of the charger 20 is connected to the second charging interface 125. At this time, the second Bluetooth SoC may reset and power on, and may output a charging control signal CHRG_EN# to the gate of the switching transistor Q2. When the charging control signal CHRG_EN# is a high level, the switching transistor Q2 may conduct, and then the second charging module 1221 may turn off charging. That is, the charger 20 may be prohibited from charging the second battery 123. When the charging control signal CHRG_EN# is a low level, the switching transistor Q2 may cut off, and the second charging module 1221 may operate normally. That is, the charger 20 may be allowed to charge the second battery 123. Further, the second control module 1222 may also include a resistor R6. An end of the resistor R6 may be connected between the GPIO pin of the second Bluetooth SoC and the resistor R4, and the other end of the resistor R6 may be grounded, so as to provide a default chargeable state for the second control module 1222. A value of the resistor R6 may be greater than a value of the resistor R4. Based on this, when the second Bluetooth SoC is unable to be powered up and switched on due to a loss of power of the second battery 123, the charger 20 may charge the second battery 123 until the second Bluetooth SoC is normally powered up, and then the second Bluetooth SoC may take over the control on the second charging module 1221.

Different from related techniques, in the present disclosure, when the first output plug and the second output plug of the charger 20 are connected to the first charging interface 115 and the second charging interface 125, respectively, the first control module 1122 and the second control module 1222 may be communicatively connected to each other to perform charging information interactions, so as to control the first charging module 1121 and the second charging module 1221 to cooperatively charge the first battery 113 and the second battery 123, respectively. A wireless communication connection may be established between the first control module 1122 and the second control module 1222 via a wireless communication technique (e.g., Bluetooth, Purple Peak, WiFi, etc.). Alternatively, a wired communication connection may be established between the first control module 1122 and the second control module 1222 via a communication cable, an optical fiber, etc. Further, charging information may include interaction information, such as a connection state between the first charging interface 115 and/or the second charging interface 125 and the charger 20 (i.e., whether the first charging interface 115 and/or the second charging interface 125 and the charger 20 are connected), the current battery level of the first battery 113 and/or the second battery 123 and whether the current battery level is in a fully-charged state, etc. Therefore, the present disclosure can not only improve an endurance capacity of the smart glasses 10 when the smart glasses 10 realize stereo by supplying power to the first speaker 114 and the second speaker 124 through the first battery 113 and the second battery 123, respectively, but also control the first charging module 1121 and the second charging module 1221 to cooperatively charge the first battery 113 and the second battery 123 by exchanging charging information of the left and right glasses temples (i.e., the first glasses temple assembly 11 and the second glasses temple assembly 12) through a communication connection between the first control module 1122 and the second control module. Technical problems, such as only one of the first battery 113 and the second battery 123 is charged and the other is not charged, the difference between the current battery level of the first battery 113 and the current battery level of the second battery 123 are relatively large, etc., are avoided, thereby ensuring the normal use of the smart glasses.

It should be noted that the cooperative charging in the present disclosure refers to that a charging process of the first battery 113 and a charging process of the second battery 123 are associated after the first control module 1122 is communicatively connected to the second control module 1222. In other words, the first battery 113 and the second battery 123 may either start charging at the same time or start charging one by one, but regardless of any manner, the first charging module 1121 and the second charging module 1221 may control corresponding charging powers during the charging processes of the first battery 113 and the second battery 123, so that both the first battery 113 and the second battery 123 may be fully charged.

Merely by way of example, in combination with FIG. 3, during the charging process of the smart glasses 10 by the charger 20, a communication connection may be established between the first control module 1122 and the second control module 1222, so as to perform an interaction on a connection state between the charger 20 and the first charging module 1121 and/or the second charging module 1221. When the first control module 1122 fails to establish the communication connection with the second control module 1222, the first control module 1122 and the second control module 1222 may periodically re-issue connection requests until the communication connection is established. Before the communication connection between the first control module 1122 and the second control module 1222 is established, the first charging module 1121 and the second charging module 1221 may be prohibited from charging the first battery 113 and the second battery 123, respectively, so as to avoid an unfavorable scenario that only one of the first battery 113 and the second battery 123 is charged and the other one is not charged. Further, when the first control module 1122 detects that the first charging interface 115 is connected to the first output plug of the charger 20, it may be considered that the first charging module 1121 is connected to the charger 20, and the first Bluetooth SoC resets and powers on. At this time, the first control module 1122 may not only control the first charging module 1121, but also send charging information such as “the first charging module 1121 is connected to the charger 20” to the second control module 1222. Similarly, when the second control module 1222 detects that the second charging interface 125 is connected to the second output plug of the charger 20, it may be considered that the second charging module 1221 is connected to the charger 20, and the second Bluetooth SoC resets and powers on. At this time, the second control module 1222 may not only control the second charging module 1221, but also send another charging information such as “the second charging module 1221 is connected to the charger 20” to the first control module 1122.

It should be noted that since it is difficult for the user to make the first output plug and the second output plug of the charger 20 be connected to the first charging interface 115 and the second charging interface 125 at the same moment, respectively, there is a time difference between the first charging interface 115 and the second charging interface 125 being connected to the charger 20, respectively, which leads to a sequence order of the charging information interactions between the first Bluetooth SoC and the second Bluetooth SoC. Therefore, when the first charging interface 115 and the second charging interface 125 are connected to the charger 20 successively, a former connected one may send interaction charging information such as “connected” to a latter connected one, and the latter connected one may also send the interaction charging information such as “connected” to the former connected one, which increases the reliability of the interactions between the two Bluetooth SoCs. In some embodiments, no interaction charging information may be sent, thereby simplifying the interaction process.

Further, when the first charging module 1121 and the second charging module 1221 are connected to the charger 20, the first control module 1122 and the second control module 1222 may control the first charging module 1121 and the second charging module 1221 to cooperatively charge the first battery 113 and the second battery 123, respectively. For example, each of the first Bluetooth SoC and the second Bluetooth SoC may send a low level control signal CHRG_EN#, which respectively causes the switching transistors Q1 and Q2 to cut off, and the first charging module 1121 and the second charging module 1221 to operate normally, thereby allowing the charger 20 to charge the first battery 113 and the second battery 123. At the same time, the first control module 1122 and the second control module 1222 may also control the first charging indicator 1123 and the second charging indicator 1223 to issue the charging indications. For example, the first charging indicator 1123 and the second charging indicator 1223 may emit red colored light visible to the human eyes, respectively. Conversely, when either the first charging module 1121 or the second charging module 1221 is not connected to the charger 20, the first control module 1122 and the second control module 1222 may prohibit the first charging module 1121 and the second charging module 1221 from charging the first battery 113 and the second battery 123, respectively, so as to avoid the unfavorable scenario that only one of the first battery 113 and the second battery 123 is charged and the other one is not charged. For example, each of the first Bluetooth SoC and the second Bluetooth SoC may send a high level control signal CHRG_EN#, which respectively causes the switching transistors Q1 and Q2 to conduct, and the first charging module 1121 and the second charging module 1221 to turn off charging, thereby prohibiting the charger 20 from charging the first battery 113 and the second battery 123. At the same time, the first control module 1122 and the second control module 1222 may also prohibit the first charging indicator 1123 and the second charging indicator 1223 from issuing the charging indications. For example, neither the first charging indicator 1123 nor the second charging indicator 1223 may emit the red colored light visible to the human eyes.

Based on the above descriptions, the first control module 1122 may be configured to send first indication information (e.g., the charging information indicating that the first charging module 1121 is connected to the charger 20) to the second control module 1222 when the first charging module 1121 is connected to the charger 20, and the second control module 1222 may be configured to control the second charging module 1221 to charge the second battery 123 and send second indication information to the first control module 1122 when the second charging module 1221 is connected to the charger 20 and the second charging module 1221 receives the first indication information. The first control module 1122 may be further configured to control the first charging module 1121 to charge the first battery 113 in response to the second indication information. Further, the second control module 1222 may be configured to prohibit the second charging module 1221 from charging the second battery 123 when the second charging module 1221 is not connected to the charger 20 or does not receive the first indication information, and the first control module 1122 may be configured to prohibit the first charging module 1121 from charging the first battery 113 when the first charging module 1122 is not connected to the charger 20 or does not receive the second indication information. In such way, both the first battery 113 and the second battery 123 can be normally charged, which avoids the unfavorable scenario that only one of the first battery 113 and the second battery 123 is charged and the other one is not charged. At the same time, when the first control module 1122 sends the first indication information and does not receive the second indication information within a predetermined time, the first control module 1122 may be configured to send an alarm signal. In other words, when the first charging interface 115 is connected to the charger 20 and the second charging interface 125 is not connected to the charger 20, the first control module 1122 may control the first charging indicator 1123 to generate the alarm signal, such as a blinking red light or a sharp beeping sound, so as to prompt the user to connect the second output plug of the charger 20 to the second charging interface 125 again or to perform other charging checks until the alarm signal is eliminated. When the second charging interface 125 is connected to the charger 20 and the first charging interface 115 is not connected to the charger 20, the second control module 1222 may control the second charging indicator 1223 to generate an alarm signal, such as a flashing red light or a sharp beeping sound, so as to prompt the user to connect the first output plug of the charger 20 to the first charging interface 115 again or to perform other charging checks until the alarm signal is eliminated. Therefore, the normal charging can be ensured.

Further, during the charging process, the first control module 1122 and the second control module 1222 may be configured to perform an interaction on the current battery level of the first battery 113 and the current battery level of the second battery 123. For example, the first Bluetooth SoC may not only detect the current battery level of the first battery 113, but also send the interaction information such as “the current battery level of the first battery 113 is XXX” to the second Bluetooth SoC, and/or the second Bluetooth SoC may not only detect the current battery level of the second battery 123, but also send the interaction information such as “the current battery level of the second battery 123 is XXX” to the first Bluetooth SoC, so as to facilitate the first control module 1122 and/or the second control module 1222 to compare a size relationship between the current battery level of the first battery 113 and the current battery level of the second battery 123. Based on this, the first control module 1122 and the second control module 1222 may be configured to control the first charging indicator 1123 and the second charging indicator 1223 to issue the charging indications based on a lower one of the current battery level of the first battery 113 and the current battery level of the second battery 123. For example, in response to determining that the first battery 113 is fully charged first and the second battery 123 is fully charged later, the first charging indicator 1123 may continue to issue the charging indication until the second battery 123 is fully charged. That is, even if the first battery 113 is no longer charged because the first battery 113 is already fully charged in the process, the first charging indicator 1123 may continue to issue the charging indication in consideration of the fact that the first battery 113 and the second battery 123 are an organic whole for the smart glasses 10. At the same time, since the first control module 1122 and the second control module 1222 perform a real-time interaction on the current battery levels of the first battery 113 and the second battery 123 at a certain frequency during the charging process, the first control module 1122 and the second control module 1222 may be configured to adjust charging powers of the first charging module 1121 and the second charging module 1221 based on the difference between the current battery level of the first battery 113 and the current battery level of the second battery 123. For example, in response to determining that the current battery level of the first battery 113 is greater than the current battery level of the second battery 123, the first control module 1122 may control the first charging module 1121 to reduce a charging output current and/or a charging output voltage, thereby reducing a charging speed of the first battery 113, so as to make the current battery level of the first battery 113 be consistent with the current battery level of the second battery 123. The second control module 1222 may be further configured to control the second charging module 1221 to increase the charging output current and/or the charging output voltage, thereby increasing a charging speed of the second battery 123, so as to make the current battery level of the second battery 123 be consistent with the current battery level of the first battery 113.

As charging continues, the first control module 1122 and the second control module 1222 may be configured to perform an interaction on at least one of a fully-charged state of the first battery and a fully-charged state of the second battery, in addition to performing the interaction on the current battery level of the first battery 113 and the current battery level of the second battery 123. For example, the first Bluetooth SoC may not only detect the current battery level of the first battery 113 and determine whether the current battery level of the first battery 113 reaches a predetermined battery level threshold, but also send interaction information such as “the first battery 113 is fully charged” to the second Bluetooth SoC when the current battery level of the first battery 113 reaches the battery level threshold. The second Bluetooth SoC may not only detect the current battery level of the second battery 123 and determine whether the current battery level of the second battery 123 reaches the predetermined battery level threshold, but also send interaction information such as “the second battery 123 is fully charged” to the first Bluetooth SoC when the current battery level of the second battery 123 reaches the battery level threshold. Based on this, the first control module 1122 and the second control module 1222 may control the first fully-charged indicator 1124 and the second fully-charged indicator 1224 to issue the fully-charged indications when each of the first battery 113 and the second battery 123 is in the fully-charged state. For example, each of the first fully-charged indicator 1124 and the second fully-charged indicator 1224 may emit blue color light visible to the human eyes. Conversely, the first fully-charged indicator 1124 and the second fully-charged indicator 1224 may prohibit the first fully-charged indicator 1124 and the second fully-charged indicator 1224 from issuing the fully-charged indications when either the first battery 113 or the second battery 123 is not in the fully-charged state. For example, neither the first fully-charged indicator 1124 nor the second fully-charged indicator 1224 may emit the blue colored light visible to the human eyes. Based on the relevant descriptions, in response to determining that the first battery 113 is fully charged first and the second battery 123 is fully charged later, the first fully-charged indicator 1124 may not directly issue the fully-charged indication when the first battery 113 is fully charged, but the first charging indicator 1123 may still issue the charging indication. The first fully-charged indicator 1124 may issue the fully-charged indication until the second battery 123 is fully charged. That is, during the charging process, although the first battery 113 is no longer charged because the first battery 113 is fully charged, the first fully-charged indicator 1124 may not issue the fully-charged indication in consideration of the fact that the first battery 113 and the second battery 123 are an organic whole for the smart glasses 10.

Based on the above descriptions, the first control module 1122 may be configured to send third indication information (e.g., the interaction information indicating that the first battery 113 is fully charged) to the second control module 1222 when the first battery 113 is in the fully-charged state. The second control module 1222 may be configured to control the second fully-charged indicator 1224 to issue the fully-charged indication and send fourth indication information (e.g., the interaction information indicating that the second battery 123 is fully charged) to the first control module 1122 when the second battery 123 is in the fully-charged state and receives the third indication information from the first control module 1122. The first control module 1122 may be configured to control the first fully-charged indicator 1124 to issue the fully-charged indication in response to the fourth indication information from the second control module 1222. Further, the second control module 1222 may be configured to prohibit the second fully-charged indicator 1224 from issuing the fully-charged indication when the second battery 123 is not in the fully-charged state or the second control module 1222 does not receive the third indication information from the first control module 1122. The first control module 1122 may be configured to prohibit the first fully-charged indicator 1124 from issuing the fully-charged indication when the first battery 113 is not in the fully-charged state or the first control module 1122 does not receive the fourth indication information from the second control module 1222. Alternatively, the second control module 1222 may be configured to send third indication information (e.g., the interaction information indicates that the second battery 123 is fully charged) to the first control module 1122 when the second battery 123 is in the fully-charged state. The first control module 1122 may be configured to control the first fully-charged indicator 1124 to issue the fully-charged indication and send fourth indication information (e.g., the interaction information indicating that the first battery 113 is fully charged) to the second control module 1222 when the first battery 113 is in the fully-charged state and the first control module 1122 receives the third indication information from the second control module 1222. The second control module 1222 may be configured to control the second fully-charged indicator 1224 to issue the fully-charged indication in response to the fourth indication information from the first control module 1122. Further, the first control module 1122 may be configured to prohibit the first fully-charged indicator 1124 from issuing the fully-charged indication when the first battery 113 is not in the fully-charged state or the first control module 1122 does not receive the third indication information from the second control module 1222. The second control module 1222 may be configured to prohibit the second fully-charged indicator 1224 from issuing the fully-charged indication when the second battery 123 is not in the fully-charged state or the second control module does not receive the fourth indication information from the first control module 1122. In other words, a control module corresponding to the one of the first battery 113 and the second battery 123 that is in the fully-charged state first may send corresponding indication information to the other control module corresponding to the one of the first battery 113 and the second battery 123 that is in the fully-charged state later. In this way, both the first battery 113 and the second battery 123 can be normally charged, which avoids the unfavorable scenario that only one of the first battery 113 and the second battery 123 is charged and the other one is not charged.

It should be noted that the smart glasses 10 may also include only one of the first charging indicator 1123 and the second charging indicator 1223, and only one of the first fully-charged indicator 1124 and the second fully-charged indicator 1224. In other words, the smart glasses 10 may be disposed with only one charging indicator and one fully-charged indicator. The charging indicator and the fully-charged indicator may be electrically connected to the first main board 112 and the second main board 122, respectively. Alternatively, the charging indicator and the fully-charged indicator may be electrically connected to one of the first main board 112 and the second main board 122 simultaneously. Based on this, when either the first charging interface 115 or the second charging interface 125 is not connected to the charger 20, the charging indicator may not issue the charging indication. When the first charging interface 115 and the second charging interface 125 are connected to the charger 20, and either the first battery 113 or the second battery 123 is not in the fully-charged state, the charging indicator may issue the charging indication. When the first battery 113 and the second battery 123 are in the fully-charged state, the fully-charged indicator may issue the fully-charged indication.

The above descriptions are only a portion of embodiments of the present disclosure, and are not intended to limit the scope of the present disclosure. Any equivalent device or equivalent process transformed using the contents of the specification of the present disclosure and the accompanying drawings, or directly or indirectly applied in other related technical fields, are all included in the scope of the present disclosure.

What is claimed is:

1. Smart glasses, comprising a first glasses temple assembly and a second glasses temple assembly, wherein
the first glasses temple assembly includes a first charging module, a first battery, and a first control module,
the second glasses temple assembly includes a second charging module, a second battery, and a second control module, and
the first control module and the second control module are communicatively connected to each other to perform charging information interactions, so as to control the first charging module and the second charging module to cooperatively charge the first battery and the second battery, respectively.

2. The smart glasses of claim 1, wherein the first control module and the second control module are configured to:
perform an interaction on a connection state between a charger and at least one of the first charging module and the second charging module,
when the first charging module and the second charging module are connected to the charger, control the first charging module and the second charging module to cooperatively charge the first battery and the second battery, respectively, and
when either the first charging module or the second charging module is not connected to the charger, prohibit the first charging module and the second charging module from charging the first battery and the second battery, respectively.

3. The smart glasses of claim 2, wherein
the first control module is configured to send first indication information to the second control module when the first charging module is connected to the charger,
the second control module is configured to control the second charging module to charge the second battery and send second indication information to the first control module when the second charging module is connected to the charger and the second control module receives the first indication information, and
the first control module is further configured to control the first charging module to charge the first battery in response to the second indication information.

4. The smart glasses of claim 3, wherein
the second control module is configured to prohibit the second charging module from charging the second battery when the second charging module is not connected to the charger or does not receive the first indication information, and
the first control module is configured to prohibit the first charging module from charging the first battery when the first charging module is not connected to the charger or does not receive the second indication information.

5. The smart glasses of claim 4, wherein when the first control module sends the first indication information and does not receive the second indication information within a predetermined time, the first control module is configured to send an alarm signal.

6. The smart glasses of claim 2, wherein
the first glasses temple assembly further includes a first charging indicator,
the second glasses temple assembly further includes a second charging indicator,
when the first charging module and the second charging module are connected to the charger, the first control module and the second control module are configured to control the first charging indicator and the second charging indicator to issue charging indications, respectively, and
when either the first charging module or the second charging module is not connected to the charger, the first control module and the second control module are configured to prohibit the first charging module and the second charging module from issuing the charging indications, respectively.

7. The smart glasses of claim 6, wherein the first control module and the second control module are configured to:
perform an interaction on a current battery level of the first battery and a current battery level of the second battery, and control the first charging indicator and the second charging indicator to issue the charging indications based on a lower one of the current battery level of the first battery and the current battery level of the second battery.

8. The smart glasses of claim 7, wherein the first control module and the second control module are further configured to adjust charging powers of the first charging module and the second charging module based on a difference between the current battery level of the first battery and the current battery level of the second battery.

9. The smart glasses of claim 1, wherein
the first glasses temple assembly further includes a first fully-charged indicator,
the second glasses temple assembly further includes a second fully-charged indicator,
the first control module and the second control module are configured to:
perform an interaction on at least one of a fully-charged state of the first battery and a fully-charged state of the second battery;
control the first fully-charged indicator and the second fully-charged indicator to issue fully-charged indications when each of the first battery and the second battery is in the fully-charged state; and
prohibit the first fully-charged indicator and the second fully-charged indicator from issuing the fully-charged indications when either the first battery or the second battery is not in the fully-charged state.

10. The smart glasses of claim 9, wherein
the first control module is configured to send third indication information to the second control module when the first battery is in the fully-charged state, the second control module is configured to control the second fully-charged indicator to issue the fully-charged indication and send fourth indication information to the first control module when the second battery is in the fully-charged state and receives the third indication information from the first control module, and the first control module is further configured to control the first fully-charged indicator to issue the fully-charged indication in response to the fourth indication information from the second control module; or
the second control module is configured to send third indication information to the first control module when the second battery is in the fully-charged state, the first control module is configured to control the first fully-charged indicator to issue the fully-charged indication and send fourth indication information to the second control module when the first battery is in the fully-charged state and receives the third indication information from the second control module, and the second control module is further configured to control the second fully-charged indicator to issue the fully-charged indication in response to the fourth indication information from the first control module.

11. The smart glasses of claim 1, further comprising:
a visual structure, wherein the first glasses temple assembly and the second glasses temple assembly are respectively connected to both ends of the visual structure and extend in a same direction,
the first glasses temple assembly includes a first housing connected to an end of the visual structure and a first main board, the first battery, and a first speaker disposed within the first housing,
the first battery and the first speaker are electrically connected to the first main board, so as to allow the first battery to provide power to the first speaker.

12. The smart glasses of claim 11, wherein
the first glasses temple assembly further includes a first charging interface electrically connected to the first main board, the first charging interface being configured to connect to a first output plug of a charger, and
the second glasses temple assembly further includes a second charging interface electrically connected to the second main board, the second charging interface being configured to connect to a second output plug of the charger.

13. The smart glasses of claim 12, wherein the smart glasses include only one charging indicator and one fully-charged indicator, wherein the charging indicator and the fully-charged indicator are electrically connected to the first main board and the second main board, respectively.

14. The smart glasses of claim 13, wherein
when either the first charging interface or the second charging interface is not connected to the charger, the charging indicator is configured to not issue a charging indication,
when the first charging interface and the second charging interface are connected to the charger, and either the first battery or the second battery is not in a fully-charged state, the charging indicator is configured to issue a charging indication, and
when the first battery and the second battery are in a fully-charged state, the fully-charged indicator is configured to issue a fully-charged indication.

15. A method for controlling smart glasses, wherein the smart glasses comprises a first glasses temple assembly and a second glasses temple assembly, the first glasses temple assembly includes a first charging module, a first battery, and a first control module, the second glasses temple assembly includes a second charging module, a second battery, and a second control module, and the first control module and the second control module are communicatively connected to each other, the method comprising:
performing charging information interactions between the first control module and the second control module; and
controlling the first charging module and the second charging module to cooperatively charge the first battery and the second battery, respectively.

16. The method of claim 15, wherein the controlling the first charging module and the second charging module to cooperatively charge the first battery and the second battery, respectively includes:
performing an interaction on a connection state between a charger and at least one of the first charging module and the second charging module;
in response to that the first charging module and the second charging module are connected to the charger, controlling the first charging module and the second charging module to cooperatively charge the first battery and the second battery, respectively; or
in response to that either the first charging module or the second charging module is not connected to the charger, prohibiting the first charging module and the second charging module from charging the first battery and the second battery, respectively.

17. The method of claim 16, wherein the in response to that the first charging module and the second charging module are connected to the charger, controlling the first charging module and the second charging module to cooperatively charge the first battery and the second battery, respectively, includes:
sending first indication information to the second control module when the first charging module is connected to the charger;
controlling the second charging module to charge the second battery and send second indication information to the first control module when the second charging module is connected to the charger and the second control module receives the first indication information; and
controlling the first charging module to charge the first battery in response to the second indication information.

18. The method of claim 17, further comprising:
prohibiting the second charging module from charging the second battery when the second charging module is not connected to the charger or does not receive the first indication information; and
prohibiting the first charging module from charging the first battery when the first charging module is not connected to the charger or does not receive the second indication information.

19. The method of claim 16, wherein the first glasses temple assembly further includes a first charging indicator, the second glasses temple assembly further includes a second charging indicator, and the method further includes:
controlling the first charging indicator and the second charging indicator to issue charging indications, respectively, when the first charging module and the second charging module are connected to the charger; or
prohibiting the first charging module and the second charging module from issuing the charging indications, respectively, when either the first charging module or the second charging module is not connected to the charger.

20. The method of claim 14, wherein the first glasses temple assembly further includes a first fully-charged indicator, the second glasses temple assembly further includes a second fully-charged indicator, and the method further includes:
performing an interaction on at least one of a fully-charged state of the first battery and a fully-charged state of the second battery;
controlling the first fully-charged indicator and the second fully-charged indicator to issue fully-charged indications when each of the first battery and the second battery is in the fully-charged state; or
prohibiting the first fully-charged indicator and the second fully-charged indicator from issuing the fully-charged indications when either the first battery or the second battery is not in the fully-charged state.
